(19) United States
(12) Patent Application Publication
(10) Pub. No.: US 2026/0098228 A1
(43) Pub. Date: Apr. 9, 2026

(54) PROCESS FOR REMOVAL OF CHLORIDE CONTAINING COMPOUNDS AND OTHER IMPURITIES FROM FATS AND OILS

(71) Applicant: Neste Oyj, Espoo (FI)

(72) Inventors: Sami ALAKURTTI, Porvoo (FI); Laura LONKA, Porvoo (FI)

(73) Assignee: Neste Oyj, Espoo (FI)

(21) Appl. No.: 19/115,348

(22) PCT Filed: Sep. 28, 2023
(86) PCT No.: PCT/FI2023/050554

§ 371 Date: Mar. 26, 2025

(30) Foreign Application Priority Data
Oct. 3, 2022 (FI) 20225888

(51) Int. Cl. C11B 13/00; C11B 3/00; C11C 1/08

(52) U.S. Cl. CPC C11B 13/00; C11B 3/001; C11B 3/006; C11B 3/008; C11C 1/08

(57) ABSTRACT

Present disclosure relates to a novel process for removal of chloride containing compounds and other impurities from fats and oils.

### FIELD OF THE INVENTION

The present invention relates to a method for purifying feedstocks rich in organic chloride such as e.g. brown grease, gutter oil or low quality UCOs. This is achieved by partial hydrolysis or heat treatment with water which removes roughly 90% of organic chloride and in addition over 95% of phosphorus and a significant amount of metals present in the feedstock.

### BACKGROUND OF THE INVENTION

In order to utilize very low quality fats and oils to their full potential, there is a clear need for new efficient pre-processing and pre-treatment methods to reduce the amount of harmful impurities in challenging feedstocks. Chloride compounds, both inorganic and organic, are highly problematic due the corrosion of metals surfaces and equipment by chloride induced stress corrosion cracking. Current bleaching methods in the art with citric acid and bleaching earth removes phosphorus and metals efficiently from several high and medium quality feedstocks. However, the content of organic chloride is not reduced during bleaching. In fact, the amount of organic chloride is often increased, when inorganic chloride salts are converted to “hard to remove” organic chloride under acidic bleaching conditions.

Thus, there is a clear need to be able to use low quality or very low quality feedstocks for further processing such that those feedstocks become economically viable options for the production of e.g. renewable fuel sources.

Present invention addresses this problem and provides i.a. a novel method for processing of low or even very low quality feedstocks and thus enables an improved and cost-efficient method of processing such feedstock for further use in e.g. fuel preparation.

### DESCRIPTION OF THE INVENTION

As mentioned herein, present invention provides for an efficient method for processing of feedstocks to thereby lower e.g. the content of organic chloride compounds to such a level that the purified feedstock may be used for further processing.

Present invention solves the problem of removing the content of e.g. chloride containing compounds to such a level as enabling further processing of the purified feedstock and obviating the problem encountered by higher levels of chloride containing compounds present in a feedstock. Such problems may e.g. be corrosion of any apparatuses used in any further processing or fouling of catalysts.

Consequently, present invention provides for aspects wherein e.g. a novel method is presented which is simplified and yet effective. This may include omitting steps or operations seen in prior art and at the same time result in a product, a purified oil or feedstock, with low enough contaminants to allow for further processing.

In one aspect, present invention relates to a method or process for purifying a feedstock.

In one aspect, the method or process may comprise one or more steps of:
a) providing a feedstock,
b) mixing or contacting the feedstock with water,
c) heating the feedstock/water mixture resulting from b),
d) separating the water phase from the oil phase resulting from step c),
e) removing solids from the oil phase obtained from step d), to obtain an oil phase essentially free of, or with reduced amount of chloride containing compounds.

In one aspect, the method according to the invention comprises steps a)-e) without any process steps or reactions in between any one of said steps.

In a further aspect, the method according to the invention is executed such that step a) is performed and thereafter followed by step b) which in turn is followed by step c) and so on.

In a further aspect, the method according to the invention may include other steps prior to, and/or after, or in between any one of steps a) to e).

Present invention also relates to a feedstock obtainable by the method of present invention. In other words, the invention enables the preparation of a purified feedstock by employing the method of present invention.

Present invention also relates to a feedstock characterised in that the feedstock contains very low or no chloride containing compounds. The invention also relates to a feedstock with low or no content of phosphorous containing compounds and/or metal containing compounds.

The various aspects of the invention will be further elaborated upon in the below detailed description thereof.

### DETAILED DESCRIPTION OF THE INVENTION

As mentioned herein, present invention relates to a method or process for purifying a feedstock.

In one aspect, the method may comprise the steps of:
a) providing a feedstock,
b) mixing or contacting the feedstock with water,
c) heating the feedstock/water mixture resulting from b),
d) separating the water phase from the oil phase resulting from step c),
e) removing solids from the oil phase obtained from step d), to obtain an oil phase essentially free of, or with reduced amount of chloride containing compounds.

It is to be understood that the terminology “method” may be used interchangeably with “process” throughout the description.

According to the invention, the feedstock to be purified may be of any plant, animal origin, or may originate in principle from any living organism.

In one aspect, present invention does not relate to any feedstock of fossil origin, or of any synthetic origin.

In one aspect, the feedstock according to present invention may be gutter oil, trap and brown greases, low quality used cooking oil (UCO), low quality animal fat or any mixtures thereof. Thus, present invention with its method is capable of capitalising on feedstocks that are generally considered too low in quality to be further used for any purpose.

Put in another way, the feedstock to be purified or processed according to the method of present invention may be of any plant or animal origin and may thus be based on any parts, derivatives or products based on any plants or animals, or any products originating from or based on algae or microbial oils. Thus, in a wider understanding of the invention, the term “feedstock” may comprise one or more of any plant oils, plant fats, animal fats and animal oils, and mold oils, selected from e.g. used cooking oil (UCO), rapeseed oil, canola oil, colza oil, tall oil, sunflower oil, corn oil, technical/distillers corn oil (TCO), soybean oil, hemp oil, olive oil, linseed oil, cottonseed oil, mustard oil, palm oil, palm oil mill effluent (POME) oil, arachis oil, castor oil, coconut oil, animal fats such as e.g. suet, tallow, blubber, recycled alimentary fats, fish oil, starting materials produced by genetic engineering, and biological starting materials produced by microbes such as algae and bacteria and the likes, acidulated soapstock (acidified soapstock), trap grease, brown grease, gutter oil, fatty acid distillates (FAD) from e.g. rice bran oil or from palm oil (palm oil fatty acid distillate PFAD), or any combinations or mixtures thereof.

In respect of feedstocks, “Used cooking oil (UCO)” refers to oils and fats that have been used for cooking or frying in the food processing industry, in restaurants, in fast foods and at consumer level, in households.

Gutter oil is a general term for waste oils collected from sources such as fryers, grease traps, slaughterhouse waste, and fatbergs.

By the term “Brown Grease” is intended to mean any emulsion of fat, oil, grease, solids, and water separated from wastewater in a grease interceptor (grease trap) and collected for use as a fuel feedstock.

As is apparent from the above, the feedstock may comprise any oil or lipid material obtainable from any animal or plant sources, and/or may comprise any oil or lipid material obtainable from any type of fungi, such as e.g. yeasts, bacteria, Protista (such as e.g. algae and protozoa), and Monera (such as e.g. eubacteria, archaebacteria etc).

In another aspect, the feedstock may comprise one or more of plant oils, plant fats, animal fats and animal oils, microbial oils; or the feedstock comprises gutter oil, trap and brown greases, low quality used cooking oil (UCO), low quality animal fat or any mixtures thereof.

Present invention aims at and provides purified feedstocks with a reduced amount of chloride containing compounds. The chloride containing compounds may be organic or inorganic chloride containing compounds or a mixture thereof.

The terminology “reduced” is intended to mean that a certain component is present in a lower amount in any material, such as e.g. a feedstock, in relation to its presence in any material prior to any processing or its presence in e.g. a feedstock used as a starting material or raw material in any process. A reduction may mean that one or more components are reduced by 100%, and thus is essentially completely removed, or reduced by at least about 20%, such as e.g. reduced by at least about 30%, such as e.g. reduced by at least about 40%, such as e.g. reduced by at least about 50%, such as e.g. reduced by at least about 60%, such as e.g. reduced by at least about 70%, such as e.g. reduced by at least about 80%, such as e.g. reduced by at least about 85%, such as e.g. 90%, such as e.g. at least about 95%, such as e.g. at least about 97%, such as e.g. at least about 98%, such as e.g. at least about 99%. Such percentages may be measured as weight % (wt %) or volume % (vol %) or mol %, or may be a measurement of the ratio between the remaining amount of e.g. chloride containing compounds in the purified feedstock vs. unpurified feedstock.

In one aspect, present invention is capable of reducing the amount of one or more of chloride containing compounds, phosphorous containing compounds, and metal containing compounds present in the feedstock to such a degree that the remaining levels of said compounds are below the analytical detection level. In this respect, the analytical methods used to determine said compounds in the purified feedstock are intended to mean any methods known in the art.

In a particular aspect, present invention is capable of reducing or removing organic chloride containing compounds. Specifically, the term “organic chloride containing compounds” is intended to mean compounds where the chloride atom is covalently bound to a carbon atom. A non-limiting example of such chloride containing compound may be e.g. 3-MCPD esters (fatty acid esters of 3-monochloropropane-1,2-diol). However, it should be noted that numerous other organic chloride containing compounds may be removed from a feedstock by the method of present invention.

Present invention is also able to reduce the amount of phosphorous containing compounds.

Present invention is also capable of reducing the amount of metal containing compounds present in the purified feedstock.

In one aspect, present invention is capable of reducing at least one of chloride containing compounds, phosphorous containing compounds, and metal containing compounds present in the feedstock. In a further aspect, present invention is capable of reducing all three of chloride containing compounds, phosphorous containing compounds, and metal containing compounds present in the feedstock.

As mentioned herein, the feedstock is a so-called low quality feedstock. In the context of present invention, the term “low quality” is intended to mean a feedstock that may comprise a chloride content of about 50 ppm or more, such as e.g. about 75 ppm or more, such as e.g. about 100 ppm or more, such as e.g. about 125 ppm or more, such as e.g. about 150 ppm or more, such as e.g. about 175 ppm or more, such as e.g. about 200 ppm or more, such as e.g. about 225 ppm or more. However, the feedstock may also comprise a chloride content of at least about 50 ppm, such as e.g. at least about 100 ppm, such as e.g. at least about 150 ppm, such as e.g. at least about 200 ppm, such as e.g. at least about 250 ppm, such as e.g. at least about 500 ppm, such as e.g. at least about 750 ppm, such as e.g. at least about 1000 ppm, such as e.g. at least about 1500 ppm, such as e.g. at least about 1750 ppm, such as e.g. at least about 2000 ppm. As mentioned herein, the “chloride content” may be the total sum of inorganic and organic chloride compounds present in the feedstock, or may only refer separately to the amount of organic or inorganic chloride compounds present in the feedstock.

According to the invention, the feedstock is mixed or otherwise contacted with water.

In one aspect, the contacting the feedstock with water may be illustrated in step b).

The amount of water used in the method may be e.g. in a ratio (w/w) of feedstock to water of about 1:1, such as e.g. about 2:1, such as e.g. about 3:1, such as e.g. about 4:1, such as e.g. about 5:1, such as e.g. about 6:1, such as e.g. about 7:1, such as e.g. about 8:1, such as e.g. about 9:1, such as e.g. about 10:1 etc. Alternatively, the ratio may be in any range of about 4:1 to about 9:1. However, the amount of water may also be about 5 wt % (in relation to weight of feedstock), such as e.g. about 10 wt %, such as e.g. about 20 wt %, such as e.g. about 25 wt %, such as e.g. about 30 wt %, such as e.g. about 40 wt %, or alternatively in any range of about 10 wt % to about 25 wt %.

In one aspect, the amount of added water may be in any range of e.g. about 5 wt % to about 10 wt % in relation to provided feedstock. In yet a further aspect, the amount of added water may be e.g. 5 wt % in relation to provided feedstock. In another aspect, the amount of added water may be e.g. about 10 wt % in relation to provided feedstock.

In one aspect, the added water may not comprise a base or basic compound, such as e.g. an alkali metal hydroxide, an alkali metal carbonate, an alkali metal alkoxide, or any combinations thereof.

Overall, the method as a whole according to the invention, may not comprise the use of a basic compound, such as e.g. an alkali metal hydroxide, an alkali metal carbonate, an alkali metal alkoxide, or any combinations thereof.

In a further aspects, the added water does not comprise an alcohol, such as e.g. methanol or ethanol.

Overall, the method as a whole according to the invention, may not comprise the use of an alcohol, such as e.g. methanol or ethanol, or any combinations thereof.

The contacting of feedstock with water may be effected by any standard method known in the art. Non-limiting examples may be e.g. any type of mechanical stirring or agitation, or e.g. high shear mixing.

In one aspect, the feedstock/water mixture may be heated. The heating step according to the invention may be exemplified by step c) according to the invention.

In a further aspect, the heating step c) may take place at ambient pressure, such as e.g. about 1.0 atm.

In another aspect, the heating step c) may not include applying additional pressure.

In yet a further aspect, the heating step may not include heating under inert atmosphere, such as e.g. heating in the presence of nitrogen or argon gas.

The temperature at which the heating takes place may be at a temperature in range of about 200° C. to about 300° C., such as e.g. about 210° C., such as e.g. about 220° C., such as e.g. about 230° C., such as e.g. about 240° C., such as e.g. about 250° C., such as e.g. about 260° C., such as e.g. about 270° C., such as e.g. about 280° C., such as e.g. about 290° C. Alternatively, the temperature may be in any range of about 210° C. to e.g. about 290° C., such as e.g. about 220° C. to e.g. about 280° C., such as e.g. about 230° C. to e.g. about 270° C.

in one aspect, the temperature may be e.g. about 260° C.

In another aspect, the temperature may be e.g. about 230° C.

In yet a further aspect, the temperature may be in range of e.g. about 230° C. to about 260° C.

In one aspect, pressure needs to be higher than vapour pressure of water at that used temperature to keep the water in liquid form.

The heating in the method according to the invention, and which may be illustrated in step c), may be conducted for any suitable time.

The time during which heating is conducted may be e.g. about 1 minute to about 60 minutes, or 1 h to about 6 h, such as e.g. about 2 h, such as e.g. about 3 h, such as e.g. about 4 h, such as e.g. about 5 h, or alternatively at least 1 minute such as e.g. at least about 5 minutes, at least about 10 minutes, at least about 15 minutes, at least about 20 minutes, at least about 15 minutes, at least about 20 minutes, at least about 25 minutes, at least about 30 minutes, at least about 35 minutes, at least about 40 minutes, at least about 45 minutes, at least about 50 minutes, at least about 55 minutes, at least about 50 minutes.

In one aspect, the heating may be conducted during a period of e.g. 1 minute such as e.g. at least about 5 minutes, at least about 10 minutes, at least about 15 minutes, at least about 20 minutes, at least about 15 minutes, at least about 20 minutes, at least about 25 minutes, at least about 30 minutes, at least about 35 minutes, at least about 40 minutes, at least about 45 minutes, at least about 50 minutes, at least about 55 minutes, at least about 50 minutes, or for at least about 60 min.

In yet a further aspect, the heating may be conducted for e.g. about 5 minutes.

In another aspect, the heating may be conducted for e.g. about 30 minutes.

In one aspect, the heating may be conducted for e.g. about 60 minutes.

In one aspect, the heating may be conducted for e.g. about 3 h.

Without being bound to any theory, the heating of the feedstock/water mixture results in the formation of solid phosphorous containing compounds and/or metal containing compounds.

Furthermore, the heating of the feedstock/water mixture may effect a partial hydrolysis of the triglycerides present in the feedstock into free fatty acids and di-and/or mono-glycerides. Thus, partial hydrolysis of the triglycerides may be a result of the method according to the invention.

According to the invention, it is not necessary to have complete hydrolysis of the triglycerides present in the provided feedstock. In one aspect, the invention relates to at least partial hydrolysis of the triglycerides present in the provided feedstock.

In one aspect, the method may provide for a minimal hydrolysis of e.g. the triglycerides in the feedstock by treatment with water.

After completion of the heating in step c), the water or aqueous phase may be separated from the oil phase. This operation may be illustrated or exemplified by step d).

The separation of water or aqueous phase from the oil or organic phase may in principle be made by any suitable technique known in the art. Non-limiting examples of this may be e.g. centrifugation, spontaneous phase separation, settling, decantation, evaporation of the water, or any combinations thereof in any order.

The obtained oil-phase or organic phase, resulting from the separation of water in step d), may be subjected to any type of filtration or any other known technique to remove solids from a fluid, to thereby remove any solid material present in the oil phase.

Non-limiting methods of separating any solids from the oil-phase may be e.g. filtration by employing a pre-coated filter device (e.g. vertical leaf filters, candle filters, drum filters, horizontal press filters) or by non-filter-aid filtration (e.g. back-flush filter, belt and continuous cake filter, wiped filter) or any combinations thereof.

As mentioned herein, the method according to present invention may, or may not, include any method or process steps prior to e.g. step a) or after step e). One non-limiting example is that the method may comprise additional process or method steps after e.g. step e). In one exemplary aspect, the purified feedstock, i.e. the oil-phase obtained from step e) may be subjected to e.g. a bleaching step and/or a degumming step.

The bleaching step and the technique employed therein may comprise the employment of any suitable bleaching clay and/or an organic acid. Bleaching clays may be any type of e.g. various type of hydrated aluminium silicates or bleaching earths such as e.g. bentonite, attapulgite and sepiolite. Such material may be acid activated. Suitable acids may be e.g. citric acid, oxalic acid or fumaric acid.

In general, acids used alone or in combination with e.g. any type of bleaching earth me be e.g. citric acid, oxalic acid or fumaric acid as non-limiting examples.

In one aspect, bleaching clays may be used in combination with an organic acid in bleaching of the obtained oil-phase.

The bleaching may take place under the same conditions as the contacting between the feedstock and water and the subsequent heating of that mixture.

Non-limiting conditions for bleaching may be e.g. any suitable temperature, such as e.g. in range of about 15° C. to about 120° C., or about 50° C. to about 90° C., about 60° C. to about 95° C., or about 70° C. to about 90° C., or about 80° C. to about 90° C., or about 85° C., or about 75° C., or preferably about 85° C.

Furthermore, the bleaching may take place for a period of between about 30 seconds to about 1 h, such as e.g. about 30 minutes, such as e.g. about 20 minutes, such as e.g. about 15 minutes, such as e.g. about 10 minutes, such as e.g. about 5 minutes, such as e.g. about 3 minutes, such as e.g. about 1 minute prior to addition and mixing in with the adsorbent.

In one aspect, the bleaching may take place during a period of e.g. about 20 min.

Thus in one aspect, the bleaching may take place at about 85° C. for about 20 min.

The bleaching may be conducted under reduced pressure. The reduced pressure may in principle be a reduced pressure under normal pressure (1 atm, standard atmospheric pressure corresponding to 1013.25 mbar), such as e.g. at a pressure of about 100 mbar to about 900 mbar, such as e.g. about 200 mbar to about 900 mbar, such as e.g. about 300 mbar to about 900 mbar, such as e.g. about 400 mbar to about 900 mbar, such as e.g. about 500 mbar to about 900 mbar, such as e.g. about 600 mbar to about 900 mbar, such as e.g. about 700 mbar to about 900 mbar, or preferably about 800 mbar.

In one aspect, the bleaching may be conducted under reduced pressure of about 800 mbar.

As mentioned herein, the bleaching step may also be a combined bleaching and degumming process under the same conditions as mentioned for the bleaching process.

Present invention provides of a high yielding method. Thus, in one aspect, the oil-phase present in the crude unpurified feedstock is recovered by e.g. at least about 90% of the oil present in the feedstock is recovered, such as e.g. about 95%, such as e.g. about 98%, or such as e.g. about 99%, or e.g. a quantitative yield of the oil-phase present in the feedstock.

The chloride content in the obtained purified feedstock, i.e. in the oil phase obtained from the process is reduced by about 85% or more, such as e.g. about 90% or more, such as e.g. about 95% or more, such as e.g. about 98% or more, or reduced to an amount below the analytical detection level in relation to the provided feedstock in a).

Moreover, the amount of phosphorous containing compounds present in the feedstock and prior to the purification method according to the invention is reduced by at least about 70% or more, such as e.g. about 80%, such as e.g. about 85% or more, such as e.g. about 90% or more, such as e.g. about 95% or more, such as e.g. about 98% or more, or reduced to an amount below the analytical detection level in relation to the provided feedstock in a).

In one aspect, the method according to the invention may also be capable or reducing the amount of metal containing compounds present in the unpurified feedstock. The metal content of the resulting oil phase obtained from the process may be reduced by at least about 20% or more, such as e.g. about 30% or more, such as e.g. about 40% or more, such as e.g. about 50% or more, such as e.g. about 60% or more, or e.g. about 70% or more, such as e.g. about 80%, such as e.g. about 85% or more, such as e.g. about 90% or more in relation to the provided feedstock in a).

The method or process according to the invention also offers an obtained oil-phase displaying a beneficial filtration resistance such that the obtained oil-phase may be further processed without additional costly operations.

In one aspect, the filtration resistance is e.g. below about 1800 GPas/kg², such as 1700 GPas/kg² or less, such as e.g. 1500 GPas/kg² or less, such as 1300 GPas/kg² or less, such as 1000 GPas/kg² or less, such as 750 GPas/kg² or less, such as 600 GPas/kg² or less, or such as 400 GPas/kg² or less.

In a further aspect, present invention relates to a process for purifying a feedstock, the process comprising the steps of;
a) providing a feedstock,
b) mixing or contacting the feedstock with water, wherein the ration between feedstock: water is in any range of about 1:1 to about 9:1, preferably about 4:1,
c) heating the feedstock/water mixture resulting from b), wherein the temperature is in any range from about 200° C. to about 300° C., preferably about 230° C. to about 260° C., and wherein feedstock/water mixture is heated during any time span of about 1 h to about 6 h, preferably about 3 h,
d) separating the water phase from the oil phase resulting from step c),
e) removing solids from the oil phase obtained from step d), to obtain an oil phase essentially free of, or with reduced amount of chloride containing compounds, and wherein step e) is optionally followed by bleaching.

According to the invention, the method of the invention may be able to provide for one or more of;
A simplified method or procedure in the sense that it will not require applied pressure, not taking place under an inert atmosphere, not requiring addition of other agents such as e.g. alkaline components or agents,
An effective method in removing or reducing organic chlorine containing compounds, or inorganic chlorine containing compounds, or a combination or organic and inorganic chlorine containing compounds.
A reduced filtration resistance or the treated feedstock.
A maximised yield of obtained purified feedstock or conversely minimising loss of oil during the processing.

Importantly, the invention may be able to provide for a simplified cost effective method while at the same time providing for elimination or a reduction of chlorine containing compounds in an industrial scale setting. Thus, the invention provides for a minimisation in reaction steps, employing as few added components as possible and providing for a purified product containing levels of chlorine containing compounds acceptable for further processing or refinement with maximised yields of obtained purified feedstock/oil.

Present invention also relates to an oil phase obtainable from the process or method according to the invention.

In another aspect, present invention also relates to an oil-phase or purified feedstock. As is apparent from the description, the oil-phase or purified oil-phase is intended to mean the product obtained as a result of the feedstock undergoing the various steps and treatments according to the method of the invention.

The oil-phase or purified feedstock may be characterised by comprising a total chloride content of less than about 9 ppm, such as e.g. less than about 7 ppm, such as e.g. less than about 5 ppm, such as e.g. less than about 3 ppm, such as e.g. less than about 2 ppm, less than about 1 ppm etc.

The oil-phase or purified feedstock may be further characterised by comprising a phosphorus content of less than about 5 ppm, such as e.g. less than about 3 ppm, such as e.g. less than about 2 ppm, less than about 1 ppm, such as e.g. less than about 0.5 ppm, such as e.g. less than about 0.3 ppm, such as e.g. less than about 0.1 ppm.

The oil-phase or purified feedstock may also be further characterised by comprising a metal content of less than about 250 ppm, such as e.g. less than about 100 ppm, such as e.g. less than about 50 ppm, such as e.g. less than about 30 ppm, such as e.g. less than about 25 ppm, such as e.g. less than about 20 ppm, such as e.g. less than about 15 ppm, such as e.g. less than about 10 ppm.

Present invention will be further illustrated in the below seen non-limiting examples.

### Examples

In the below examples, P is intended to mean phosphorous containing compound, N is intended to mean nitrogen containing compounds, M is intended to mean metal containing compounds, FFA is intended to mean Free Fatty Acids, BG is intended to mean Brown Grease, CA is intended to mean Citric Acid, BE is intended to mean Bleaching Earth, HT is intended to mean Heat Treated.

### Example 1

Brown grease (BG) heat treatment, oil: water ratio 1:1

Brown grease FFA (Free Fatty Acids)=90.2%, N=127.8 ppm, P=18.9 ppm, total metals=835.5 ppm, total chlorides=51.2 ppm and organic chloride=51.8 ppm was mixed with water 1:1 and stirred at 230° C. for 3 h. Water and oil phase was separated by centrifugation and oil phase was filtered to remove any solids. Product contained 92.6% of FFA and removal rates were: N 35.1% (127.8 to 82.9 ppm), P 98.5% (18.9 to 0.3 ppm) and metals 93.0% (835.5 to 58.3 ppm), total chlorides 88.8% (51.2 to 5.7 ppm) and organic chloride 88.1% (51.8 to 6.2 ppm). Oil recovery 92.9%.

### Example 1.1

BG reference bleaching

Reference bleaching of Brown grease with citric acid (7000 ppm)+Tonsil removed N 25.4% (127.8 to 95.3 ppm), P 84.6% (18.9 to 2.9 ppm), metals 98.9% (835.5 to 9.6 ppm) and total chlorides 0.3% (51.2 to 51.0 ppm).

### Example 2

Trap grease heat treatment, oil: water ratio 4:1 followed by bleaching

Trap grease, FFA=60.8%, N=384 ppm, P=26.1 ppm, total metals=898 ppm, total chlorides=90.5 ppm and organic chloride=68.6 ppm was mixed with water 4:1 and stirred at 260° C. for 3 h. Water and oil phase was separated in a separation funnel and oil phase was filtered to remove any solids. Product contained 83.7% of FFA and removal rates were: total chlorides 87.5% (90.5 to 11.3 ppm), organic chloride 93.3% (68.6 to 4.6 ppm) and P 96.6% (26.1 to 0.9 ppm). Oil recovery 96.6%. The oil phase was bleached with 1000 ppm CA, 1 wt-% of BE Tonsil under standard bleaching conditions. Overall removal rates were: total chlorides 92.8% (90.5 to 6.5 ppm), N 4.2% (384 to 368 ppm), P 98.1% (26.1 to 0.5 ppm) and metals 73.3% (898 to 240 ppm). Filtration resistance 1300 GPas/kg².

### Example 2.1

Trap grease heat treatment, oil: water ratio 9:1 followed by bleaching.

Trap grease, FFA=60.8%, N=384 ppm, P=26.1 ppm, total metals=898 ppm, total chlorides=90.5 ppm and organic chloride=68.6 ppm was mixed with water 9:1 and stirred at 260° C. for 3 h. Water and oil phase was separated in a separation funnel and oil phase was filtered to remove any solids. Product contained 76.4% of FFA and removal rates were: total chlorides 89.8% (90.5 to 9.2 ppm) and organic chloride 91.2% (68.6 to 6.0 ppm) and P 96.6% (26.1 to 0.9 ppm). Oil recovery 97.6%.

Oil phase was bleached with 1000 ppm CA, 1 wt-% of BE Tonsil under standard bleaching conditions. Overall removal rates were: total chlorides 92.2% (90.5 to 7.1 ppm), N 26.0% (384 to 284 ppm), P 97.7% (26.1 to 0.6 ppm) and metals 72.5% (898 to 247ppm). Filtration resistance 1700 GPas/kg².

### Example 2.2

Trap grease reference bleaching.

Reference bleaching of Trap grease, with citric acid (1000 ppm)+1 wt-% of BE Tonsil removed total chlorides 18.1% (90.5 to 74.1 ppm), N 24.7% (384 to 289 ppm), P 58.6% (26.1 to 10.8 ppm), metals 48.3% (898 to 464 ppm). Filtration resistance 13076 GPas/kg².

### Example 2.3

Trap grease reference heat treatment without water addition followed by bleaching.

Trap grease, FFA=60.8%, N=384 ppm, P=26.1 ppm, total metals=898 ppm, total chlorides=90.5 ppm and organic chloride=68.6 ppm was heat treated at 260° C. for 5 min. Due to very slow 2 μm filtration, only a small part was filtered and only P and metals were analysed from filtered samples, rest from unfiltered sample. Removal rates from filtered sample: P 48.8% (26.1 to 13.3 ppm), metals 6.1% (898 to 843ppm). Removal rates from unfiltered sample: total chlorides 9.7% (90.5 to 81.7 ppm), organic chloride 48.8% (68.6 to 35.1 ppm) N-11.6% (384 to 428 ppm). Filtered heat treated HT product was bleached with 1000 ppm CA, 1 wt-% of BE Tonsil under standard bleaching conditions. Overall removal rates were: total chlorides 58.0% (90.5 to 38 ppm), N 11.4% (384 to 340 ppm), P 81.2% (26.1 to 4.9 ppm) and metals 53.3% (898 to 420 ppm). Filtration resistance 6564 GPas/kg².

### Example 3

Used cooking oil heat treatment, oil: water ratio 4:1 followed by bleaching

Used cooking oil, FFA=16%, N=532 ppm, P=20 ppm, total metals=400 ppm, total chlorides=75 ppm and organic chloride=55 ppm was mixed with water 4:1 and stirred at 230° C. for 3 h. Water and oil phase was separated in a separation funnel and oil phase was filtered to remove any solids. Oil recovery was 98.8%. The oil phase was bleached with 1000 ppm CA, 1 wt-% of BE Tonsil under standard bleaching conditions. Product contained 72.5% of FFA and removal rates were: total chlorides 97% (75 to 2.6 ppm), organic chloride 95% (55 to 2.6 ppm), N 24% (532 to 406 ppm), P 99% (20 to 0.2 ppm), metals 98% (400 to 7.9 ppm). Filtration resistance was 400 GPas/kg2.

### Example 3.1

Used cooking oil reference bleaching.

Reference bleaching of used cooking oil, with citric acid (1000 ppm) +1 wt-% of BE Tonsil removed total chlorides 25% (75 to 56 ppm), N 34% (532 to 351 ppm), P 80% (20 to 4.1 ppm), metals 92% (400 to 32 ppm). Filtration resistance 23956 GPas/kg².

### Example 4

Chinese gutter oil heat treatment, oil: water ratio 4:1 followed by bleaching

Chinese gutter oil, FFA=62.7%, N=550 ppm, P=42.6 ppm, total metals=2480 ppm, total chlorides=31 ppm and organic chloride=26 ppm was mixed with water 4:1 and stirred at 260° C. for 3 h. Water and oil phase was separated in a separation funnel and oil phase was filtered to remove any solids. Oil recovery was 94.9%. The oil phase was bleached with 1000 ppm CA, 1 wt-% of BE Tonsil under standard bleaching conditions. Product contained 83.1% of FFA and removal rates were: total chlorides 91% (30.9 to 2.8 ppm), organic chloride 90% (26 to 2.7 ppm), N 10% (550 to 495 ppm), P 99% (42.6 to 0.4 ppm), metals 36% (2480 to 1580 ppm). Filtration resistance was 700 GPas/kg².

### Example 4.1

Chinese gutter oil reference bleaching.

Reference bleaching of Chinese gutter oil, with citric acid (1000 ppm)+1 wt-% of BE Tonsil removed total chlorides 9% (31 to 28.1 ppm), N 13% (550 to 481 ppm), P 23% (42.6 to 32.9 ppm), metals 14% (2480 to 2135 ppm). Filtration resistance 850 GPas/kg2.

As is apparent from the illustrated examples above, present invention provides for an efficient method capable of reducing or eliminating “difficult to remove” organic chloride compounds while at the same time the oil loss is relatively low, i.e. the yield of the obtained purified oil-phase is high. Simultaneously part of glycerides are hydrolysed to FFA and the amount of other impurities are decreased such as e.g. phosphorous containing compounds and metal containing compounds.

Furthermore, the filtration resistance is significantly lower compared to reference bleaching or bleaching of reference heat treated products.

1. A process for purifying a feedstock, the process comprising:
a) providing a feedstock;
b) mixing or contacting the feedstock with water, to form a feedstock/water mixture;
c) heating the feedstock/water mixture resulting from b);
d) separating the a water phase from an oil phase resulting from step c); and
e) removing solids from the oil phase obtained from step d), to obtain an oil phase essentially free of, or with reduced amount of chloride containing compounds.

2. The process according to claim 1, wherein the feedstock is comprises:
feedstock having a chloride content of about 50 ppm or more, about 75 ppm or more, and/or of about 100 ppm or more, and/or of about 125 ppm or more, and/or of about 150 ppm or more, and/or of about 175 ppm or more, and/or of about 200 ppm or more, and/or of about 225 ppm or more.

3. The process according to claim 1, wherein the feedstock is gutter oil, trap and brown greases, low quality used cooking oil (UCO), low quality animal fat or any mixtures thereof.

4. The process according to claim 1, wherein the amount ratio (w/w) of feedstock to water is about 1:1, and/or of about 2:1, and/or of about 3:1, and/or of about 4:1, and/or of about 5:1, and/or of about 6:1, and/or of about 7:1, and/or of e.g. about 8:1, and/or of about 9:1, and/or of about 10:1.

5. The process according to claim 1, wherein the heating in step c) is at a temperature in range of about 200° C. to about 300° C., and/or of about 210° C., and/or of about 220° C., and/or of about 230° C., and/or of about 240° C., and/or of about 250° C., and/or of about 260° C., and/or of about 270° C., and/or of about 280° C., and/or of about 290° C.

6. The process according to claim 1, wherein the heating in step c) takes place under a time period of about 1 minute to about 60 minutes, or 1 h to about 6 h, and/or of about 2 h, and/or of about 3 h, and/or of about 4 h, and/or of about 5 h, or alternatively at least 1 minute and/or of least about 5 minutes, and/or of at least about 10 minutes, and/or of at least about 15 minutes, and/or of at least about 20 minutes, and/or at least about 15 minutes, and/or of at least about 20 minutes, and/or of at least about 25 minutes, and/or of at least about 30 minutes, and/or of at least about 35 minutes, and/or of at least about 40 minutes, and/or at least about 45 minutes, and/or of at least about 50 minutes, and/or at least about 55 minutes, and/or of at least about 50 minutes.

7. The process according to claim 1, wherein the heating in step c) results in a partial hydrolysis of the triglycerides present in the feedstock into free fatty acids and di- and/or mono-glycerides.

8. The process according to claim 1, wherein separating of the water phase from the oil phase resulting from step c), is accomplished by:
centrifugation, spontaneous phase separation, settling, decantation, evaporation of the water, and/or any combinations thereof.

9. The process according to claim 1, wherein the oil phase collected from the separating in step d) comprises:
subjecting the oil phase to filtration to thereby remove any solid material present in the oil phase.

10. The process according to claim 1, wherein the process comprise:
a bleaching step following step e).

11. The process according to claim 10, wherein the bleaching step comprises:
treating the oil phase with citric acid and/or bleaching earth.

12. The process according to claim 1, wherein at least about 90% of oil present in the feedstock is recovered, and/or of about 95%, and/or of about 98%, and/or of about 99%.

13. The process according to claim 1, wherein a chloride content of a resulting oil phase obtained from the process in step e) is reduced by about 85% or more, and/or of about 90% or more, and/or of about 95% or more, and/or of about 98% or more in relation to the feedstock of step a).

14. The process according to claim 1, wherein a phosphorous and/or metal content of a resulting oil phase obtained from the process is step e) is reduced by about 70% or more, and/or of about 80%, and/or of about 85% or more, and/or of about 90% or more, and/or of e.g. about 95% or more, and/or of about 98% or more in relation to the provided feedstock of step a).

15. The process according to claim 9, wherein a filtration resistance of the filtration is below about 1800 GPas/kg², and/or of 1700 GPas/kg² or less and/or of, 1500 GPas/kg² or less, and/or of 1300 GPas/kg² or less, and/or of 1000 GPas/kg² or less, and/or of 750 GPas/kg² or less, and/or of 600 GPas/kg² or less, and/or of 400 GPas/kg² or less.

16. A purified oil phase obtained from the process according to claim 1.

17. An oil phase comprising;
a) a total chloride content of less than about 9 ppm;
b) a phosphorus content of less than about 2 ppm; and
c) a metal content of less than about 250 ppm.
